(19) United States
(12) Patent Application Publication
(10) Pub. No.: US 2008/0310379 A1
(43) Pub. Date: Dec. 18, 2008

(54) Short-Distance Wireless Data Transmitting Apparatus and Method

(75) Inventors: Young-hee Lim, Gyeonggi-do (KR); Keun-ho Jang, Seoul (KR); Suk-whan Choi, Gyeonggi-do (KR)

Correspondence Address: CANTOR COLBURN, LLP, 20 Church Street, 22nd Floor, Hartford, CT, 06103, US

(73) Assignee: OPEN SOLUTION CO., LTD., Seoul (KR)

(21) Appl. No.: 12/090,959

(22) PCT Filed: Oct. 20, 2005
(86) PCT No.: PCT/KR2005/003502

§ 371 Date: Aug. 8, 2008

(51) Int. Cl. H04Q 7/24

(52) U.S. Cl. 370/338

(57) ABSTRACT

A short distance wireless data transmission system and method which are capable of minimizing data loss are disclosed. The short distance wireless data transmission system can monitor variation amount of memory data, which is buffered in the master side when data transmission errors occur, can perform re-transmission of data having transmission errors, and can perform a change toward new replacement channel without interference if variation amount of memory data, which is buffered therein, exceeds a predetermined reference value to re-transmit from data in which the first transmission error occurs thereto, such that real time data cannot be lost, although a channel change is generated by successive channel interference.

### TECHNICAL FIELD

The present invention relates to a short distance wireless data transmission system, and more particularly to a short distance wireless data transmission system and method which are capable of minimizing data loss.

### BACKGROUND ART

A Bluetooth using a 2.4 GHz industrial scientific medical (ISM) frequency band and a wireless local area network (LAN) employs a spectrum spread method whose types are a frequency hopping spread spectrum (FHSS) and a direct sequence spread spectrum (DSSS).

The DSSS is a method to obtain spread signals as spread codes that are multiplied by data, and the FHSS (, or a frequency hoping method) is a method to obtain spread signals as frequency bands that are transited according to spread codes. Especially, the frequency hopping method performs a frequency hop for a carrier frequency of signals to be spread at a predetermined time interval according to hopping patterns and transmits the signals thereto. Namely, the frequency hopping method serves to convert narrow band signals to wide band signals with respect to time average. The frequency hopping method has advantages in that a predetermined hopping pattern is formed within an ISM band to comply with a standard of each country, data can be transmitted through a frequency suitable for the pattern to minimize frequency duplication, rapid frequency conversion reduces losses by multiple paths, and configuration can be simply implemented. Therefore, presently, the frequency hopping method is adopted by low-price wireless devices (for example, Bluetooth).

However, since the prior art frequency hopping method causes a hopping regardless of interference source for the entire frequency band, if a hopping is generated in a specific frequency in which interference exists, packet loss may occur. Especially, such a situation is serious in a case where data (voice, audio and video) must be transmitted in real time. Namely, if errors in data are not recovered, data quality is deteriorated.

In order to prevent such a problem, Bluetooth (Spec. ver. 1.2) takes a hopping method, such that it monitors a frequency, at which a type of interference called an adaptive frequency hopping (AFH) occurs, for a predetermined period to avoid the frequency. Also, the Bluetooth adopts a method that, if errors occur in data due to interference generated while data is transmitted in real time, the data is retransmitted twice at most.

However, such a method to prevent the problem cannot prevent data loss from successive channel interference. Because, although the same data is retransmitted thereto twice, if errors by the successive channel interference are generated, the current channel must be changed to a new replacement channel. But, even if such a channel replacement is performed, previously repeatedly transmitted data has already been lost.

### DISCLOSURE OF THE INVENTION

Therefore, the present invention has been made in view of the above problems, and it is an object of the present invention to provide to a short distance wireless data transmission system and method which are capable of minimizing data loss which may be caused by channel interference, without performing channel hopping.

It is another object of the present invention to provide to a short distance wireless data transmission system and method which are capable of minimizing data loss which may be caused by successive channel interference, and converting a current channel to a replacement channel whose channel interference is relatively low.

In accordance with an aspect of the present invention, the above and other objects can be accomplished by the provision of a short distance wireless data transmission system, which includes a transmission data generation unit for adding a redundancy to data to be transmitted and then outputting the data, and a received data processing unit for recovering data included in received backward packet to original data, as an error bit is searched for using the redundancy included in the received backward packet, and then outputting the original data, the system comprising: a memory controller for storing inputted real time data in a memory, for reading real time data necessary for packetization from the memory to output the packet to the transmission data generation unit, for checking variation amount of data stored in the memory every time a re-transmission request of real time data in a previous frame is received through a backward packet such that the real time data of the previous frame can be re-transmitted or a channel change is requested; a transmission/reception controller for performing forward packetization for real time data outputted from the transmission data generation unit together with header information to transmit the forward packet through a setting channel, such that a channel without channel interference is searched for per a replacement channel test period to store the searched channel as a replacement channel, and present setting channel can be changed to the replacement channel when channel change of the memory controller is requested; and an RF transmitting/receiving unit for communicating the forward packet and backward packet with the slave side in wireless interface fashion.

In accordance with another aspect of the present invention, there is provided a short distance wireless data transmission system, which includes a transmission data generation unit for adding a redundancy to data to be transmitted and then outputting the data, and a received data processing unit for recovering data included in a wirelessly received backward packet to original data, as an error bit is searched for using the redundancy included in the wirelessly received backward packet, and then outputting the original data, the system comprising: a memory controller for storing real time data, which is recovered in the receiving data processing unit, in a memory address which is indicated by record position information within a forward packet, for generating subsequent record position indication information indicating the memory address in which real time data of the subsequent forward packet must be stored, and output position indication information of real time data which is presently outputted from a memory, and for outputting the information thereto; a transmission/reception controller for variably setting a setting channel according to control information within wireless received forward packet, for performing backward packetization for subsequent record position indication information and output position indication information, which is inputted from the memory controller, together with non-real time data, and for transmitting the packet thereto; and an RF transmitting/receiving unit for communicating the forward packet and backward packet with the master side in a wireless interface fashion.

According to the above-mentioned configuration, as the master side designates position information in a memory, in which transmitted real time data must be recorded, and the slave side returns position information, which records real time data subsequent to the transmitted real data, to the master side, the master side compares the designated position information with the returned position information to determine as to whether data loss occurs due to channel interference, such that it can re-transmit the data if data loss occurs.

Here, since the master side is buffering the real time data, an amount of buffered data is monitored and the same data is repeatedly transmitted. Namely, if the data amount of the buffered memory exceeds a predetermined reference value, a setting channel is changed to a new replacement channel without interference to perform re-transmission from the first lost data. Therefore, the short distance wireless data transmission system according to the present invention can prevent data loss due to channel interference.

### DESCRIPTION OF DRAWINGS

The above and other objects, features and other advantages of the present invention will be more clearly understood from the following detailed description taken in conjunction with the accompanying drawings, in which:

FIG. 1 is a block diagram of a short distance wireless data transmission system according to an embodiment of the present invention;

FIG. 2 is a block diagram of a packet transmitted/received from/by a short distance wireless data transmission system according to an embodiment of the present invention;

FIG. 3 is a flow chart for describing a search procedure of a replacement channel for performing short distance wireless data transmission according to an embodiment of the present invention;

FIG. 4 is a flow chart for describing a channel change procedure according to an embodiment of the present invention, in a case where successive interference occurs in setting channel;

FIG. 5 illustrates time axes showing the search procedure of replacement channel illustrated in FIG. 3; and

FIG. 6 illustrates time axes showing the channel change procedure illustrated in FIG. 4.

### BEST MODE

Now, preferred embodiments of the present invention will be described in detail with reference to the annexed drawings. In the following description, a detailed description of known functions and configurations incorporated herein will be omitted when it may make the subject matter of the present invention rather unclear.

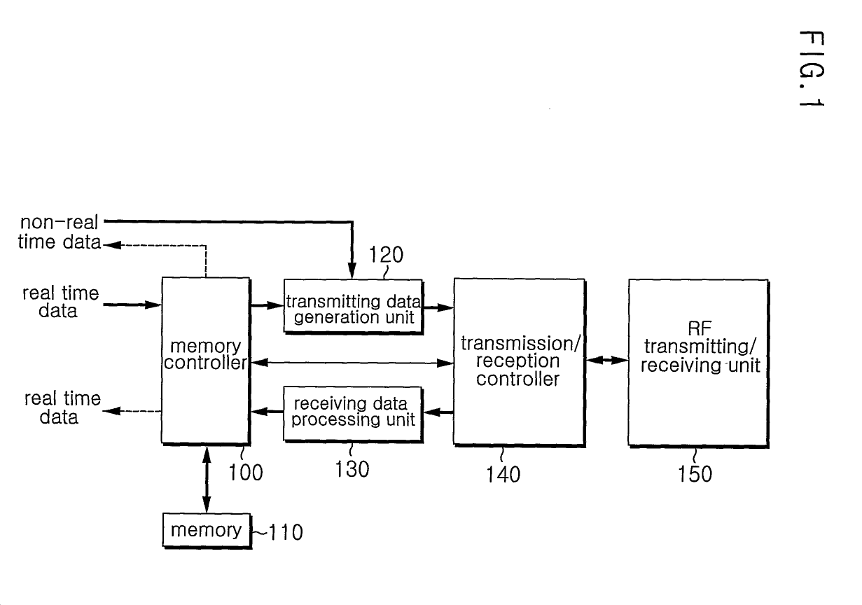

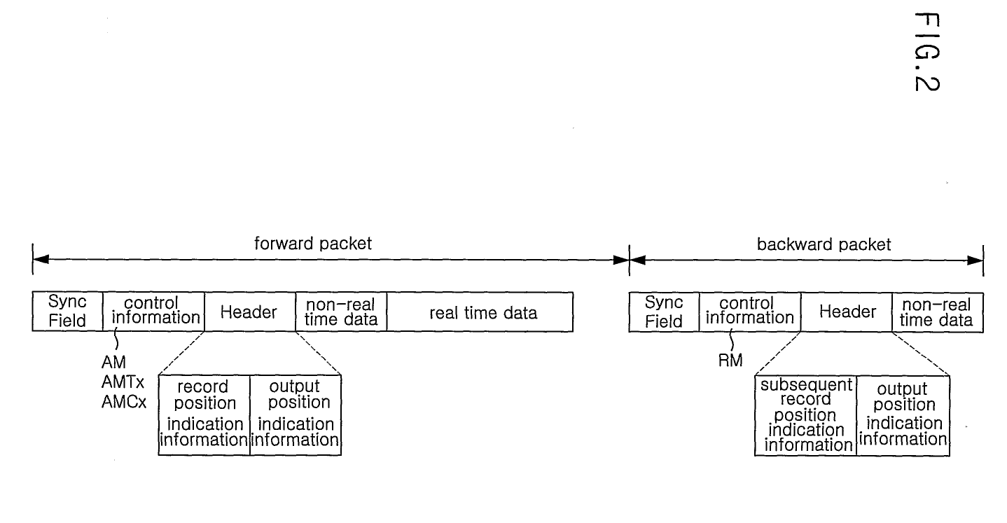

FIG. 1 is a block diagram of a short distance wireless data transmission system according to an embodiment of the present invention. FIG. 2 is a block diagram of a packet transmitted/received from/by a short distance wireless data transmission system according to an embodiment of the present invention.

Firstly, when a short distance wireless data transmission system located at a master side according to an embodiment of the present invention inputs real time data R/L SURROUND from a decoder AC-3 which processes signals reproduced in optical media, the system can packetized the data and performs short distance wireless data transmission for the packets based on the configuration of FIG. 1. Afterwards, a short distance wireless data transmission system located at a slave side receives and processes the wireless transmitted packets such that audio reproduced in the optical media can be outputted through a speaker. With reference to the attached drawings, the procedures are described in detail below.

The short distance wireless data transmission systems according to an embodiment of the present invention includes a memory controller 100, a memory 110, a transmitting data generation unit 120, a receiving data processing unit 130, a transmission/reception controller 140, and an RF transmitting/receiving unit 150.

When the short distance wireless data transmission systems is operated as a master, the memory controller 100 stores real time data from a decoder in the memory 110, and reads real time data, which is necessary for a packet, from the memory 100 to output the data to the transmission data generation unit 120 which will be described later. Also, the memory controller 100 at the master side determines as to whether there is a retransmission request of real time data transmitted to a previous frame through a backward packet transmitted from the slave side, if the retransmission request exists, variation amount of data stored in the memory 110 is checked. After that, the memory controller 100 retransmits real time data, which was transmitted to the previous frame, thereto, or requests a channel change to the transmission/reception controller 140.

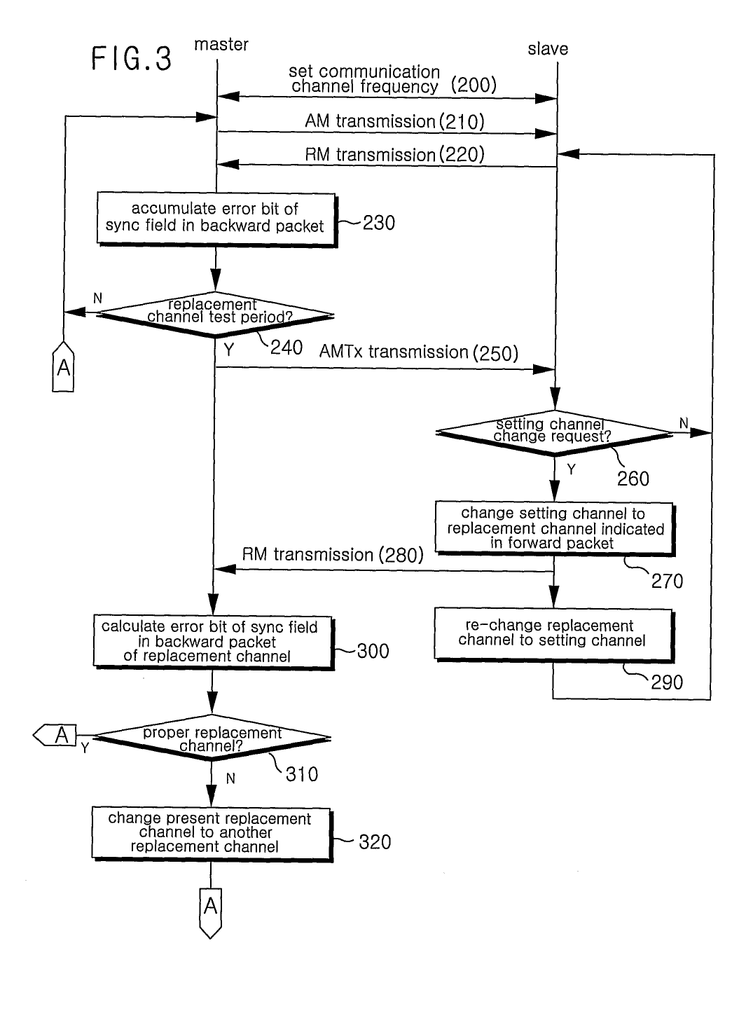

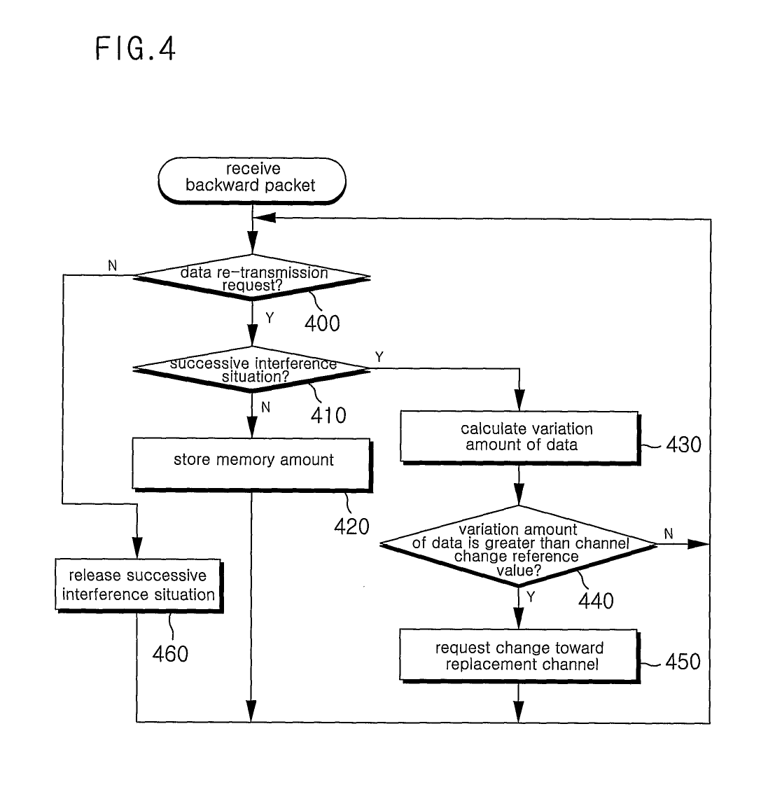

The channel change request procedure and the check procedure for variation amount of data stored in the memory 100 will be described in detail later, with reference to FIG. 3 and FIG. 4.

When the short distance wireless data transmission system is operated as a slave, the memory controller 100 stores real time data, which is recovered in the receiving data processing unit 130, which will be described later, in an address of memory 100 indicated by record position information within a forward packet transmitted from the master. Also, the system generates subsequent record position indication information indicating an address of the memory 100 in which real time data of a subsequent forward packet must be stored, and output position indication information of real time data currently outputted from the memory 110, and then outputs them thereto. Such procedures will be described in detail later, with reference to FIG. 3 and FIG. 4.

Each transmission data generation unit 120 at the master and slave sides adds minimum redundancy for performing error recovery to data (real time data and non-real time data) to be transmitted, and then outputs them thereto. Such a transmission data generation unit 120 includes a compression unit for compressing real time data like the prior art short distance wireless data transmission system, a scrambler for scrambling compressed real time data, an RS encoder/interleaver, and a forward error correction (FEC) encoder.

The receiving data processing unit 130 searches for error bits to recover and output the original data, using the redundancy included in received packets (forward packet, backward packet). In order to recover the data processed in the transmission data generation unit 120, such receiving data processing unit 130 includes a de-interleaver, an RS decoder, a de-scrambler, a recovering unit and FEC decoder.

On the other hand, the transmission/reception controller 140 at the master side performs forward packetization for real time data and non-real time data, which are inputted from the transmission data generation unit 120, together with header information, and then transmits the forward packets through a setting channel. Also, the transmission/reception controller 140 searches for channels which do not have channel interference, and then stores the searched channels therein as a replacement channel. Afterward, when the memory controller 100 requests a channel change request, the transmission/reception controller 140 changes the currently set channel (hereinafter referred to as a ‘setting channel’) to the replacement channel, thereby communicating with the slave. Program data for such a procedure are stored in an internal memory included in the transmission/reception controller 140.

On the contrary, the transmission/reception controller 140 at the slave side variably sets a current setting channel to a replacement test channel or a replacement channel. Also, the transmission/reception controller 140 performs backward packetization for subsequent record position indication information inputted from the memory controller 100 at the slave side together with non-real time data, and then transmits the packets thereto.

Here, the transmission/reception controller 140 has a function to detect sync information. Also, although the memory controller 100 and the transmission/reception controller 140 are illustrated in FIG. 1 with separation, they can be implemented with a single IC chip. In addition, the single IC chip may further include the transmitting data generation unit 120 and the receiving data processing unit 130.

The RF transmitting/receiving units 150, which are included in the respective short distance wireless data transmission system at the master and slave sides, communicate packets with one another, in a wireless interface fashion.

With reference to FIG. 2, packets transmitted/received between the short distance wireless data transmission system at the master and slave sides are described in detail.

Firstly, a forward packet transmitted from a master to a slave includes a sync field in which sync information is recorded, a control information field in which communication channel indication information is recorded, a header field in which record position information for indicating record position of real time data and output position information for indicating output position of data in a memory, and a field in which real time data and non-real time data are recorded, respectively.

On the other hand, a backward packet transmitted from a slave to a master includes a sync field in which sync information is recorded, a control information field in which a response message (RM) is recorded, a header field in which subsequent record position indication information indicating an address of the memory in which real time data must be stored, and an output position indication information of real time data currently outputted from the memory, and a field in which non-real time data are recorded.

Here, the record position information and output position information, which are included in the forward packet, are generated in the memory controller 100 at the master side, and provided to the transmission/reception controller 140. Also, the subsequent record position indication information and the output position indication information, which are included in the backward packet, are generated in the memory controller 100 at the slave side, and provided to the transmission/reception controller 140 at the slave side.

Although the above-mentioned description about each block for processing real time data and non-real time data is based on figures, circuit configuration can be modified to comply with uses of the master and slave. Namely, when the system is used as a slave, the transmission data generating unit 120 can be modified as function blocks for generating real time data or must be removed therefrom.

A method for transmitting data in the above-mentioned short distance wireless data transmission system is described in detail below.

Each transmission/reception controller 140, which is included in the short distance wireless data transmission systems at the master and slave sides, set a channel frequency for data packet transmission after a system initialization procedure. Here, such a channel set for data packet transmission is referred to as a “setting channel.”

The embodiment according to the present invention selects 10 of 79 frequencies of a 2.4 GHz band, which are evenly spread, in order to perform a connection trial. Namely, the embodiment selects frequencies (0, 8, 16, . . . , 72) corresponding to a multiple of 8. Here, such selection is performed because the system is randomly operated with respect to these frequencies at the initial time and time for searching for a frequency through which transmission/reception are successive can be saved. When transmission/reception are successive through one of the above-mentioned frequency channels, the transmission/reception controller 140 at the master side determines that there is no interference for a channel in the vicinity of the channel through which transmission/reception are successive, and then selects the vicinity channel as a first setting channel Fc.

When a setting channel is selected on the basis of the above-mentioned procedure, the master and slave performs transmission/reception of real time data therebetween through the setting channel Fc. Namely, the real time data outputted from the decoder starts to be recorded in the memory 110 through the memory controller 100 at the master side. The embodiment according to the present invention is implemented under the assumption that size of real time data recorded in the memory 10 is 120 bytes and size of real data outputted from the memory 110 is 144 bytes.

If real data necessary for packetization is recorded in the memory 110, the memory controller 110 reads real time data for forward packetization of 144 bytes from the memory 110, and then outputs them to transmission data generation unit 120. Also, the memory controller 110 outputs record position information for indicating record position of real time data (, which corresponds to address information recorded in the memory 110) to the transmission/reception controller 140. After that, the transmission/reception controller 140 at the master side performs forward packetization for the header information, which includes the record position information, real time data and control information, and then outputs the forward packet to the RF transmitting/receiving unit 150 in a wireless fashion.

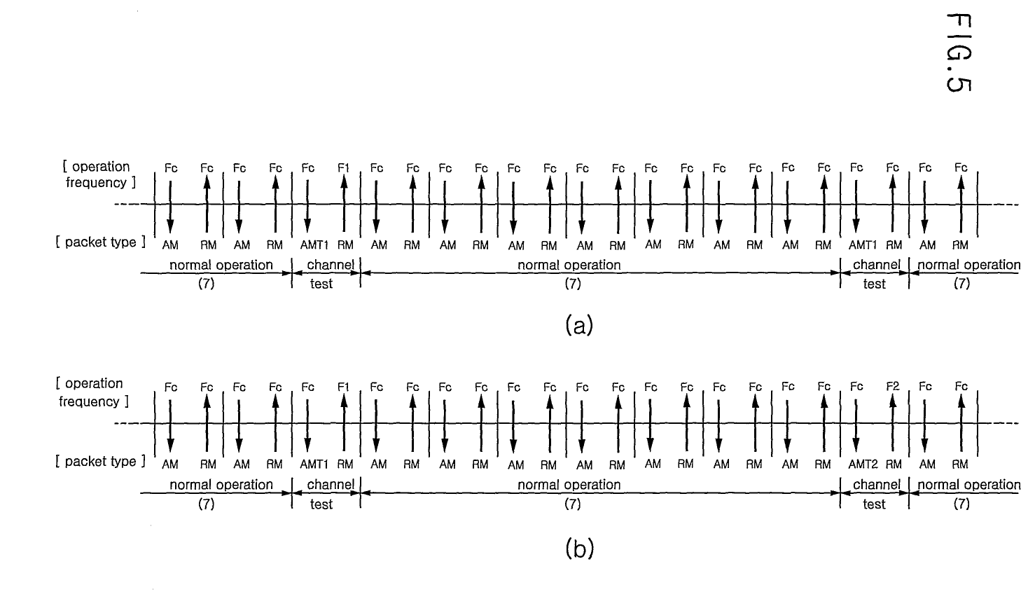

Such forward packets are transmitted through a setting channel in a data transmission interval, and through a replacement channel in a channel test interval. As shown in FIG. 5, the embodiment according to the present invention is implemented such that 8 frames are configured as a super frame, data transmission is performed in 7 frames in the super frame through the setting channel Fc, and a channel test is performed in one channel.

With respect to FIG. 3 to FIG. 5, a procedure from testing for a temporary replacement channel to storage of the tested channel as a substantial replacement channel is described below.

Firstly, the transmission/reception controllers 140 at the master and slave sides sets a channel frequency for mutual communication therebetween in step 200, in which the channel frequency is a setting channel Fc.

When the setting channel Fc without interference is found, the transmission/reception controller 140 at the master side forms a forward packet having a structure shown in FIG. 2, and then transmits real time data, in which control information in the transmitted forward packet includes an AM message, in step 210. The AM message is a command indicating that a backward packet is transmitted through a present setting channel Fc. When the transmission/reception controller 140 at the slave side receives the forward packet including such an AM message, it correspondingly transmits a backward packet whose control information includes a response message RM to the master side in step 220.

The transmission/reception controller 140 at the master side accumulates error bit of sync field in the backward packet received through the setting channel Fc in step 230. Such accumulation is a method to check as to whether channel interference exists. As demand occasions, the method may check as to a number of error bits in real time data or non-real time data, which are inserted in the received packet.

Afterwards, the transmission/reception controller 140 at the master side, which accumulates error bit of sync field in the backward packet, checks as to whether a replacement channel test period is identified, in step 240. As shown in FIG. 5, the embodiment according to the present invention is implemented such that, the replacement channel test period is identified in the super frame period, or 8th frame. If the replacement channel test period is not identified on the basis of the test result of step 240, the transmission/reception controller 140 at the master side retransmits the forward packet including the AM message to the slave side through the present channel, or the setting channel Fc, and receives a backward packet including an RM message corresponding to the transmitted forward packet to accumulate error bit of sync field. The embodiment according to the present invention is implemented such that the transmission/reception controller 140 at the master side accumulates error bit of sync field for backward packets of 7 frames.

On other hand, if the replacement channel test period is identified on the basis of the test result of step 240, the transmission/reception controller 140 at the master side transmits a forward packet including an AMTx message, indicative of change toward a replacement channel for testing, to the slave side in step 250, and then changes the setting channel of the transmission/reception controller 140 to a replacement channel for testing. The AMTx message includes replacement channel information for testing. Here, the replacement channel for testing, which is temporarily set in the replacement channel test interval, is preferably set to a frequency channel which is spaced apart from the present setting channel Fc by a predetermined distance, in order to prevent channel interference. Because there is high probability of channel interference at frequencies in a vicinity of setting channel Fc in which channel interference is generated. The replacement channel for testing is denoted by F1 in FIG. 5.

On the other hand, when control information in the received forward packet includes the AMTx message requesting change of the setting channel in step 260, the transmission/reception controller 140 at the slave side changes the present setting channel Fc to a replacement channel for testing, which is indicated by the forward packet, in step 270. Afterwards, the transmission/reception controller 140 at the slave side transmits a backward packet including an RM message through a corresponding replacement channel for testing in step 280.

Accordingly, the transmission/reception controller 140 at the master side receives the backward packet through the replacement channel for testing, and calculates error bit of sync field in the received backward packet in step 300. Afterwards, based on the calculation, the transmission/reception controller 140 determine as to whether the present replacement channel for testing can be set as a proper replacement channel in step 310. Such determination method is performed such that the error bit of sync field in the replacement channel test interval within the super frame is compared with accumulation average of error bit of sync field in the data transmission interval within a corresponding super frame.

If the error bit of sync field of the backward packet, which is received through the replacement channel for test F1, is less than the accumulation average of error bit of sync field of the backward packet, which is received through the setting channel Fc in the data transmission interval within the same super frame, the replacement channel for test F1 is determined to have very small channel interference.

Consequently, the transmission/reception controller 140 at the master side firstly sets a replacement channel for testing in a replacement channel test interval within a super frame, which is periodically performed, and then stores the replacement channel for testing therein as a replacement channel, if the error bit of sync field of the backward packet, which is received through the channel is less than the accumulation average of error bit of sync field of the backward packet, which is received the data transmission interval within a corresponding super frame. Also, the transmission/reception controller 140 successively checks as to whether channel interference is generated in the stored replacement channel at every replacement channel test interval within the repeated super frame, through step 210 to step 310. If successive interference is generated in the replacement channel, a new replacement channel for test F2 is set in step 320 to check channel interference. If the check result shows no channel interference, the replacement channel for test F2 is set to a new replacement channel.

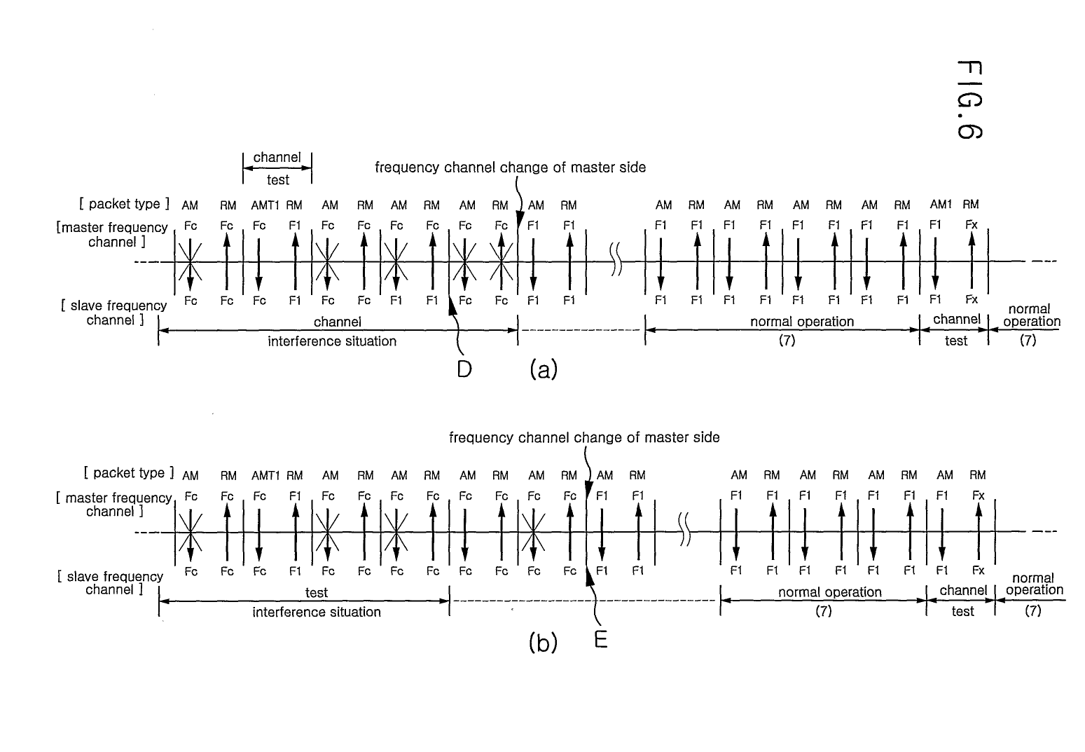

With reference to FIG. 4 and FIG. 6, described is a procedure where teal time data transmitted through the setting channel Fc are newly transmitted through the replacement channel (F1 or F2) due to successive interference.

Firstly, real time data, which is processed by forward packetization and transmitted through the setting channel Fc, is recovered through the received data processing unit 130 at the slave side, and then stored in the memory 110 according to control of the memory controller 100 at the slave side. Here, the real data is stored at an address of the memory, which is indicated by record position information (for example, A0) included in the received forward packet. When the real time data is completely stored in the memory address indicated by the record position information (A0), the memory controller 100 at the slave side generates subsequent record position indication information (for example, A1) indicating an memory address in which real time data of subsequent forward packet, and then outputs the memory address to the transmission/reception controller 140 at the slave side. The subsequent record position indication information A1 is included in the backward packet to be inputted to the memory controller 100 at the master side. Here, the memory controller 100 at the slave side controls the memory 110 such that stored real time data can be outputted only if the real time data are stored in the memory 110 exceeds the predetermined critical value. Also, the memory controller 100 at the slave generates output position indication information An of the real time data presently outputted from the memory 110 and then transmits the information to the transmission/reception controller 140 at the slave side. According to the output position indication information An, real time data of the slaves, which are connected to the master at different time points, can be synchronously outputted thereon. Namely, when the real time data are stored in the memory address indicated by output position information within the forward packet, the memory controller 100 at the slave side reads the real time data in the memory and then performs output control.

Such a memory controller 100 at the slave side generates subsequent record position indication information and output position indication information to be inputted to the transmission/reception controller 140 at the at the slave side. The transmission/reception controller 140 at the salve performs backward packetization for the inputted information and non-real time data, and then transmits them to the master.

The master side inputs the backward packet including the subsequent record position indication information and output position indication information, in which the received information is recovered in the received data processing unit 130 and then inputted to the memory controller 100 at the master side.

The memory controller 100 at the master side checks as to whether there is a re-transmission request of real time data, which are transmitted in a previous frame, from the recovered information in step 400. Such a check method is performed such that the record position information of the real time data, which is transmitted in a previous frame, is compared with subsequent record position indication information within the backward packet. For example, when the record position information of the real time data, which is transmitted in a previous frame, is A0, if subsequent record position indication information, which is received through the backward packet, is A0, such a result means that the real time data is not normally transmitted thereto due to channel interference.

As such, based on determination as to whether there is a data re-transmission request, if there is a data re-transmission request, the memory controller 100 at the master side checks as to whether such a retransmission request successively exists in step 410. If the check result show no successive interference situation, the memory controller 100 stores an amount of data, which is presently stored in the memory 110, or a memory amount, in step 420, and then re-transmits real time data, which is transmitted in a previous frame, thereto through the setting channel Fc.

On the other hand, if the check result is a successive interference situation, the memory controller 100 at the master side proceeds to step 430 and then calculates variation amount of data stored in the memory. Here, the variation amount of data is memory amount stored in step 420, which is calculated as present memory amount is subtracted from memory amount when the first re-transmission is requested. If the variation amount of memory data in the real time data re-transmission interval exceeds a channel variation reference value in step 440, the memory controller 100 at the master side determines that there is a successive interference in the setting channel Fc, and then requests a change toward the replacement channel to the transmission/reception controller 140 at the master side in step 450, in which the replacement channel is tested in FIG. 3 to prevent loss of real time data.

Namely, the memory controller 100 at the master side checks as to whether memory data variation satisfies a channel change condition from a time when the first re-transmission is requested to the present time, when data re-transmissions are repeatedly requested. When the determination is positive, re-transmission is no longer performed and instead a change toward the replacement channel having been tested is requested.

When a change toward the replacement channel is requested, the transmission/reception controller 140 at the master side transmits a forward packet, in which an AMCx message indicative of a channel change is included as control information, to the slave side, such that the master and slave can change present setting channel Fc to the replacement channel F1 without interference.

Afterwards, the master side re-reads real time data, which must be previously and repeatedly re-transmitted, from the memory, and then performs re-transmission, such that the slave side can receive the repeatedly re-transmitted real time data and a series of real time data which are subsequent therefrom.

Therefore, although a change towards a replacement channel is performed due to successive channel interference, the system according to the present invention cannot lose real time data.

FIG. 6(a) and FIG. 6(b) illustrate examples each of which shows that a setting channel Fc is changed to a replacement channel F1, in which such a change is performed because successive channel interference is existed in the setting channel Fc. Here, notations D and E denote frequency channel change times of the slave, respectively.

The short distance wireless data transmission system according to the present invention can monitor variation amount of memory data, which is buffered in the master side when data transmission errors occur, can perform re-transmission of data having transmission errors, and can perform a change toward new replacement channel without interference if variation amount of memory data, which is buffered therein, exceeds a predetermined reference value to re-transmit from data in which the first transmission error occurs thereto, such that real time data cannot be lost, although a channel change is generated by successive channel interference.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A short distance wireless data transmission system, which includes a transmission data generation unit for adding a redundancy to data to be transmitted and then outputting the data, and a received data processing unit for recovering data included in received backward packet to original data, and then outputting the original data, the system comprising:
a memory controller for storing inputted real time data in a memory, for reading real time data necessary for packetization from the memory to output the packet to the transmission data generation unit, for checking variation amount of data stored in the memory every time a re-transmission request of real time data in previous frame is received through a backward packet such that the real time data of the previous frame can be re-transmitted or a channel change is requested;
a transmission/reception controller for performing forward packetization for real time data outputted from the transmission data generation unit together with header information to transmit the forward packet through a setting channel, such that a channel without channel interference is searched for per a replacement channel test period to store the searched channel as a replacement channel, and present setting channel can be changed to the replacement channel when a channel change of the memory controller is requested; and
an RF transmitting/receiving unit for communicating the forward packet and backward packet with the slave side in wireless interface fashion.

2. The system as set forth in claim 1, wherein the memory controller provides record position information of real time data, which is read from the memory, and output position information, which is calculated from output position indication information included in the backward packet, to the transmission/reception controller, in which the record position information and the output position information is a part of header information.

3. The system as set forth in claim 2, wherein the memory controller re-transmits real time data transmitted in a previous frame if record position information of real time data transmitted in the previous frame is identical to subsequent record position indication information within the backward packet, and requests channel change if variation amount of memory data in retransmission intervals of real time data exceeds a channel change reference value.

4. The system as set forth in claim 1, wherein the transmission/reception controller searches for the replacement channel without channel interference such that accumulation average of error bit of sync field in the backward packet, which is received through the setting channel for a predetermined interval, is compared with error bit of sync field of backward packet which is received through the replacement channel in a replacement channel test interval.

5. A short distance wireless data transmission system, which includes a transmission data generation unit for adding a redundancy to data to be transmitted and then outputting the data, and a received data processing unit for recovering data included in received backward packet to original data, and then outputting the original data, the system comprising:
a memory controller for storing real time data, which is recovered in the receiving data processing unit, in a memory address which is indicated by record position information within a forward packet, for generating subsequent record position indication information indicating the memory address in which real time data of the subsequent forward packet must be stored, and output position indication information of real time data which is presently outputted from a memory, and for outputting the information thereto;
a transmission/reception controller for variably setting a setting channel according to control information within wireless received forward packet, for performing backward packetization for subsequent record position indication information and output position indication information, which is inputted from the memory controller, together with non-real time data, and for transmitting the packet thereto; and
an RF transmitting/receiving unit for communicating the forward packet and backward packet with the master side in wireless interface fashion.

6. The system as set forth in claim 5, wherein the memory controller outputs real time data from the memory if the real time data is stored in the memory address which is indicated by output position information within the received forward packet.

7. A method for transmitting short distance wireless data, comprising the steps of:
storing real time data to be transmitted in a memory;
reading the real time data for packetization from the memory to perform forward packetization of the real time data, non-real time data, and header information, and transmitting the forward packet to a slave side through the setting cannel;
checking as to whether there is a data re-transmission request in a backward packet which is transmitted from the slave side through the setting channel;
comparing variation amount of data, which is stored in the memory, with a predetermined channel change reference value, if the data re-transmission request exists;
after real time data in a previous frame, which receives a re-retransmission request, is read from the memory based on the comparison result, performing re-transmission to the slave side or requesting a change toward a replacement channel without interference to the slave side, in which the replacement channel is searched for over a replacement channel test interval; and
performing transmission/reception of the forward packet and backward packet through the replacement channel.

8. The method as set forth in claim 7, wherein the forward packet includes:
a sync field in which sync information is recorded;
a control information field in which communication channel indication information is recorded;
a header field in which record position information for indicating record position of real time data and output position information for indicating data output position on a memory is recorded; and
a field in which non-real time data and real time data are recorded, respectively.

9. The method as set forth in claim 7, wherein the backward packet includes:
a sync field in which sync information is recorded;
a control information field in which a response message is recorded
a header field in which subsequent record position indication information, which indicates a memory address in which real time data is recorded, and output position indication information of real time data which is presently outputted from a memory; and
a field in which non-real time data are recorded.

10. The method as set forth in claim 7, wherein the replacement channel is set to a replacement channel for testing, when an accumulation average of error bit of sync field in the backward packet, which is received through the setting channel for a predetermined interval, is greater than error bit of sync field of the backward packet, which is received through the replacement channel for testing, which is temporarily set in a replacement channel test interval.

11. The method as set forth in claim 7, wherein the replacement channel for testing, which is temporarily set in the replacement channel test interval, is set to one of frequency channels, which is spaced apart from the present setting channel frequency by a predetermined distance.

12. A method for transmitting short distance wireless data, comprising the steps of:
storing real time data in a forward packet, which is received through a setting channel, in a memory address which is indicated by record position information which is transmitted together with the real data;
performing backward packetization for non-real time data, record position indication information including record position in which real time data must be stored in a subsequent forward packet, and output position indication information of real time data which is presently outputted from the memory, and then transmitting the packet to a master side; and
transmitting the backward packet while a communication channel is varied according to control information in a received forward packet.

13. The method as set forth in claim 12, further comprising the step of:
reading and outputting real time data from the memory if the real time data is stored in the memory address which is indicated by output position information within the forward packet.

14. The system as set forth in claim 3, wherein the transmission/reception controller searches for the replacement channel without channel interference such that accumulation average of error bit of sync field in the backward packet, which is received through the setting channel for a predetermined interval, is compared with error bit of sync field of backward packet which is received through the replacement channel in a replacement channel test interval.
